(19) United States
(12) Patent Application Publication
(10) Pub. No.: US 2001/0034730 A1
(43) Pub. Date: Oct. 25, 2001

(54) Data-driven self-training system and technique

(76) Inventors: Inderpal S. Bhandari, Scarsdale, NY (US); Krishnakumar Ramanujam, White Plains, NY (US); Rajiv Pratap, White Plains, NY (US)

Correspondence Address: FULBRIGHT & JAWORSKI, LLP, 666 FIFTH AVE, NEW YORK, NY, 10103-3198, US

(21) Appl. No.: 09/815,435

(22) Filed: Mar. 22, 2001

Related U.S. Application Data
(60) Provisional application No. 60/191,361, filed on Mar. 22, 2000.

(51) Int. Cl. G06F 7/00

(52) U.S. Cl. 707/7; 707/102

(57) ABSTRACT

An automated training system and method for providing personalized instruction or advice to a plurality of users or students in a simple, easy-to-use manner to improve their performance in their respective domain, i.e., specific filed of human activity such as sports, stock trading, gardening, etc. The system analyzes the user's performance data to determine domain-specific performance metrics and generates advice/instruction based on the performance metrics.

### FIELD OF THE INVENTION

The present invention relates generally to self-instruction, and, more particularly, to a system and method for automating the process of self-instruction in various domains, i.e., specific field of human activity, such as sports, stock trading, gardening, etc.

### BACKGROUND OF THE INVENTION

Every person needs to constantly improve or upgrade his or her skills (or learn new ones) in order to succeed. This is true of every field of human endeavor. For example, training sessions are conducted by various companies to equip employees with the techniques required to handle their jobs. Along the same lines, homemakers attend classes to improve their parenting, cooking and other skills.

In many cases, such training is conducted by specialized personnel (such as the training staff referred to above). However, the vast majority of people, though dedicated, and anxious to improve in their respective fields, are largely unable to benefit from professional advice, due to factors such as time, convenience and cost.

Today, sophisticated data collection, data analysis, rule-based system and networking technologies can be used together to help this segment of people. For example, amateur sports persons use a large number of devices and tools to collect and monitor their data, i.e., wristwatches that track heart rate, etc. to aid runners to improve their performance. Similarly, people use various computer programs (such as spreadsheets, databases, specialized statistics packages, etc.) to enter, store and analyze data, and infer strategies for improvements. Also, people often use automated rule-based systems to assist in the diagnosis based on symptoms that are provided as input to these rule-based systems. Finally, with the advent of the Internet, people can access a large number of computer programs on a server quickly, efficiently, cost effectively, and at their own convenience.

Currently, in the area of self-improvement and training, these technologies are used largely independent of each other. The end-result is that the systems and techniques that exist do not fit the requirement of being easy-to-use, personalized, convenient and cost-effective. For example, if one used a watch to collect data, it is not a simple matter to interface to an analysis program. Or, if one input one's data into an analysis program, it is not clear that a non-technical user would know what to do next or for that matter, whether they were learning anything useful from the analysis. Or, while various on-line training methodologies exist today, they suffer from many drawbacks. On-line books and instruction manuals, while providing a cost-effective and convenient means of training, are not personalized. On the other hand, online one-on-one sessions with a human expert, while certainly personalized, are often wasteful of the expert's time (as he/she generally must deal with each student in a general way before homing on the particular student's problem), and consequently, are not sustainable when the student/teacher ratio becomes too large.

### OBJECTS OF THE INVENTION

It is an object of the present invention to provide a method and system to enable large numbers of people (users) to collect data about their performance in the field of their choice and receive personalized instruction or advice to improve their performance in a simple, easy-to-use manner.

Another object of the present invention is to provide a method and system to enable those users to provide these data as input into a computer system comprising of powerful analysis programs.

A further object of this invention is to provide a method and system to enable the users to query these data in the computer system to obtain information about performance metrics.

A yet another object of this invention is to provide a method and system to enable users to obtain interesting and useful facts about their performance that are hidden in the data.

A still another object of this invention is to provide a method and system for automated feedback to the user about his/her performance, with tips on how to improve his/her performance.

A still yet another object of this invention is to provide a method and system to decide when the intervention of a professional coach or trainer is required, and advise the user of this fact.

Various other objects of the present inventions will become readily apparent from the ensuing detailed description of the drawings and the documentation incorporated in the attached Appendix.

### SUMMARY OF THE INVENTION

Therefore, in accordance with an embodiment of the present invention, the system and method provide personalized instruction to a plurality of people, i.e., users or students, via a small number of experts in a domain where the students can follow a learning-by-doing approach. That is, the students can learn something, apply that knowledge empirically by doing that something, and repeat the learn/apply process.

In accordance with an embodiment of the present invention, the system for self-improvement appropriately links the current technologies to provide an automated training system that is easy-to-use, convenient, personalized and cost effective. However, the linkages must reflect the following realities: first, the system must be scalable to accommodate a large number of users. Second, the user (i.e., the average person) has to act as his/her own trainer, and hence, must be made aware of the kind of data to collect as well as of the methods for analyzing these data. Third, the guidance received from the software programs must be usable by non-technical users who are not well-versed in statistics, databases, etc.

In accordance with an embodiment of the present invention, a system and method are provided to enable people to collect, input, process, query and analyze their data, over a computer network, such as the internet. A user logs on to a computer system (referred to as a “server”) over the network, and uses a data collection module of the computer system to collect data that is appropriate for his/her particular domain, discipline or field. The data collected by the user are then analyzed using an analyzer module, to generate performance metrics for the user. These performance metrics are finally used as inputs an instruction module, which generates advice to the user, based on these metrics.

In accordance with an embodiment of the present invention, the data collection module provides templates that advise the user about the attributes to collect for the particular domain (the user can define his/her own templates, if desired). The user selects a template for data collection upon which the data collection module generates an appropriate form for data collection, which the user can print and fill out to collect data. When the data has been collected in this manner, the user can then use a data input module of the computer system to transmit the collected data over the network to the server.

In accordance with an embodiment of the present invention, the data collection module, instead of generating forms for the user to collect data by hand, accepts data in the form of computer files in certain standard formats. The data input module then transmits these data over the network to the server, where they are processed, and the query application generated, as noted herein.

In accordance with an embodiment of the present invention, the user may collect data using remote, portable devices such as a Personal Digital Assistant (PDA), notebook computer, palmtop computer, cellular phone, speech-enabled device, “wearable computer”, handheld game device, etc. Preferably, the user can obtain the data collection programs from the server. The collected data are transmitted over the network to the server by using appropriate communication means (such as wireless transmission, infrared techniques, etc.).

In accordance with an embodiment of the present invention, the data collected by the user is tagged with certain user characteristics, e.g., the age, gender, weight, height, etc. These characteristics are transmitted to the server along with the user's performance data.

In accordance with an embodiment of the present invention, the data collected by the user and transmitted to the server are stored in a relational database management system.

In accordance with an embodiment of the present invention, the analyzer module consists of a querying application, which allows the user to ask questions about his/her performance. The output of the querying application can consist of specific performance metrics for the user.

In accordance with an embodiment of the present invention, the analyzer module consists of a querying application as well as a processing sub-module for data mining that generates interesting patterns related to the user's performance.

In accordance with an embodiment of the present invention, the query application is similar to the query application described in a pending U.S. application Ser. No. 09/416,414, filed on Oct. 12, 1999, entitled “Method and Apparatus for Finding Hidden Patterns in the Context of Querying Applications,” which is incorporated herein by reference in its entirety, and allows the user to ask questions about his/her performance. The output of such a querying application would consist of answers related to specific performance metrics for the user, as well as certain interesting patterns about his/her performance, discovered in accordance with the principles laid out in the aforementioned application.

In accordance with an embodiment of the present invention, the instruction module comprises a characterizing sub-module and a rule-based advice sub-module. The characterizing sub-module accepts inputs (user performance data, user characteristics, etc.), and casts them into situations for the rule-based advice sub-module. The rule-based advice sub-module (generated by supplying inputs from human experts in various domains, disciplines and fields) accepts such situations as input, and generates zero or more pieces of advice for each such situation. It is appreciated that the rule-based advice sub-module may not necessarily generate an advice for each situation.

In an embodiment of the present invention, the rule-based advice sub-module of the instruction module has a built-in “escape mechanism”, whereby it automatically detects situations when it is obvious that the advice given to the user is being ignored, or followed incorrectly, or when the rule-based advice sub-module has exhausted all advice for the user. In such circumstances, the rule-based advice sub-module informs the user that it is time for the user to seek a human advice or a personalized human instruction, i.e., personal trainer or coach.

In accordance with an embodiment of the present invention, the instruction module compares and correlates advice given to various users, so as to determine the effectiveness of each advice across a wide range of users. The instruction module can use this determination in selecting an appropriate advice for a user. In this manner, the advice generated by the instruction module can be prioritized, with the advice that is determined to be generally ineffective being assigned a lower priority or being eliminated from consideration.

In accordance with an embodiment of the present invention, a minimal version of the instruction module may be included, in which the “escape mechanism” noted herein, may not be present. In other words, the minimal instruction module cannot detect situations in which the system generated advice is not being followed, or being followed inadequately by the user.

In accordance with an embodiment of the present invention, the analysis and instruction modules may be used in conjunction with any query application already present on the user's computer system (either locally, or over a network). In this case, an external processing module is required to generate interesting patterns about the user's performance. The instruction module detects queries being issued to the query application, and appends the answers to these queries with interesting patterns and advice for the user.

In accordance with an embodiment of the present invention, the server may be located or present on the user's computer, i.e., the network is not present. In such a situation, the various modules would all be present on the same computer system. Thus, the data input using the data input module are stored on the same computer as that of the user, and any “transmission” of data is local to the user's computer.

### BRIEF DESCRIPTION OF THE DRAWINGS

The following detailed description, given by way of example, and not intended to limit the present invention solely thereto, will be best be understood in conjunction with the accompanying drawings:

FIG. 1 is a block diagram representing an embodiment of an automated training system (ATS) of the present invention; and

FIG. 2 is a flow chart describing the process by which the instruction module locates an appropriate rule or advice for a user.

### DETAILED DESCRIPTION OF THE EMBODIMENTS

The present invention is readily implemented by presently available communication apparatuses and electronic components. The invention finds ready application in virtually all communication systems, including but not limited to the Internet, Intranet, Extranet, local area network (LAN), wide area network, (WAN), cable network, wireless network, satellite network, private or public network, and the like.

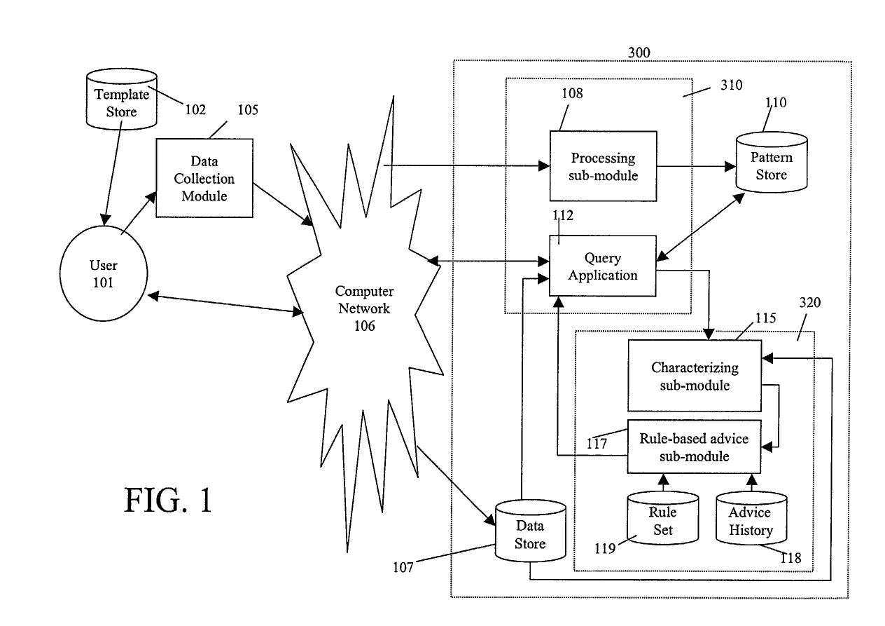

Turning now to FIG. 1, there is illustrated a block diagram of an automated training system (ATS) of the present invention. The user 101 collects data related to his/her particular domain using a data collection module 105. It is appreciated that the data can represent performance of an individual, a group of individuals, a team as a single unit or entity, etc. That is, the performance data represents the performance of a baseball team as a whole, the performance of a department comprising many employees, etc. To aid in data collection, the user 101 may make use of a template store 102, which indicates the kind of data to be collected for the particular domain. The template store 102 provides the user 101 with the data attributes to be collected for the selected domain. The data attributes may include domain-specific attributes (for example, gardening related attributes can include season, temperature, type of soil, type of plant, etc.) as well as user-specific attributes (such as experience, height, weight, gender, age, etc.). Those skilled in the art will recognize that the user 101 may collect data using a variety of means, e.g., paper forms, electronic data files, portable devices such as personal digital assistants, etc. The user 101 then supplies the collected data to the data collection module 105, which transmits the data over a computer network 106. Alternatively, the user 101 transmit the collected data to the data collection module 105 over the computer network 106. That is, user 101 can access the data collection module 105 only via the computer network 106 (not shown).

The computer system 300 comprises an analysis module 310 having a processing sub-module 108 and a query application 112, and an instruction module 320 having a characterizing sub-module 115 and a rule-based advice sub-module. Although not shown, as noted herein, the computer system 300 can additionally include the data collection module 105. It is appreciated that the various module and sub-modules of the computer system 300 can reside in a single server or in a multiple number of servers, each connected to the computer network 106.

In accordance with our aspect of the present invention, the ATS comprising the computer system 300, template system 102 and the data collector module can operate without the computer network 106. That is, the ATS of the present invention is contained entirely within a personal computer or a portable device.

The computer system 300 stores the data in a data store 107. The data can be also sent to the processing sub-module 108 of the analysis module 310. The processing sub-module 108 mines the data to discover hidden patterns, which are stored in a Pattern Store 110. Those skilled in the art will recognize that the use of the processing sub-108 module in this manner, to discover hidden patterns offline, is an optimization, for reasons of efficiency. The processing sub-module 108 can be also used to discover patterns in real-time, i.e., when the user 101 uses the system 300 to get advice.

The user 101 interacts with the system 300 through the query application 112 of the analysis module 310. The user 101 issues a query to the query application 112 over the computer network 106. For example, in a golf application, a query can comprise “What is my putting success rate for distances in the range 5-10 feet?”. The query application 112 directs the query to the data store 107, which returns an answer, in terms of the user's performance metrics, to the query application 112. For example, an answer to the query can be “2 out of 8 or 25%”.

In a call center application example, a query can comprise “how many customers were satisfied for calls received by the call center between noon and 4 pm in the week of Mar. 15-22, 2001?”. An answer to such query can be “1,000 out of 5,000 or 20%”.

The query application 112 also issues the query to the pattern store 110. The pattern store 110 responds with a set of relevant patterns. The query application 112 returns the answer and the relevant patterns to the user 101 over the computer network 106. Alternatively, the system 300 can operate without the processing sub-module 108 and/or the pattern store 110. In such a case, the query application 112 finds the patterns related to the query in real-time. Preferably, the query application 112 includes a data mining application to find such patterns in real-time.

It is appreciated that one skilled in the art understands the term “relevant patterns” to mean patterns in the data uncovered by the data mining application, i.e., the processing sub-module 108. In the context of the pending U.S. application Ser. No. 09/416,414, the relevant patterns refer to the alerts generated by the query application.

The user 101 can also obtain advice, in addition to information about his/her performance metrics. In such a case, the query application 112 transmits the answer and/or the relevant patterns to the characterizing sub-module 115 of the Instruction Module 320 as input. The characterizing sub-module 115 also has access to the user data in the data store 107. From these inputs, the characterizing sub-module 115 characterizes the answer and relevant patterns into a set of situations. In accordance with an embodiment of the present invention, the characterizing sub-module 115 can use an absolute method to characterizing the situation. For example, in a golf application, if the metric describes the percentage of putts made and missed, the characterizing sub-module 115 can characterize the situation as “missing most putts” if the user makes less than 25% of the putts, or as “missing many putts” if the user makes between 25% and 50% of the putts, and so on. In such a case, if a particular pattern describes the user as missing 80% of the putts, and makes 20% of them, the instruction module 320 characterizes the situation as “missing most putts”. Alternatively, the characterizing sub-module 115 can characterize the situation, by comparing the metric in the pattern to the user's average performance or comparing the metric in the pattern to the average performance of all users of the system. For example, in the golf application described herein, the characterizing sub-module 115 can characterize the situation as “missing most putts” if the number of putts the user missed is at least 20% more than his average, and as “missing many putts” if the number of putts the user missed is between 10-20% above his average. In such case, if the user, on an average, misses 70% of his putts, the instruction module 320 categorizes the situation in the pattern as “missing many putts”. Similarly, the instruction module 320 can characterize the situation based on the average performance of all users. Those skilled in the art will recognize that various other means of characterizing the situation are possible, such as categorization, percentile, fuzzy logic, etc.

In a call center application example, the characterizing sub-module can characterize the situation as “most customers satisfied” if more than 50% of the customers are satisfied, “some customers satisfied”, if between 25% and 50% of the customers are satisfied, and so on. In such a case, if a particular pattern describes the call center as having 80% of the customers as satisfied, the instruction module 320 characterizes the situation as “most customers satisfied”. As before, a different characterization scheme, that compares the customer satisfaction rate to the overall rate experience by the call center, or to that of other similar call centers, can be used, resulting in a different characterization of the same pattern.

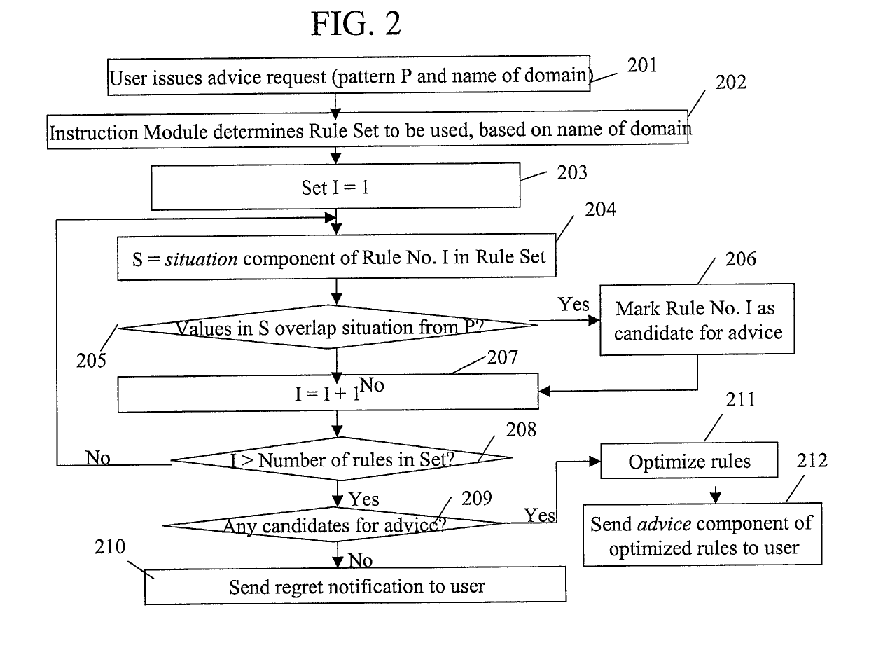

The characterizing sub-module 115 then supplies the characterized situation as an input to the rule-based advice sub-module 117. The advice sub-module 1 17 is responsible for generating advice to the user 101 based on the characterized situation. Although only one rule set 119 is shown, the advice sub-module 1 17 can access one or more rule sets 119 to generate the appropriate advice. It is appreciated that for each domain, there is a specific rule set that is applicable to the hidden patterns. In other words, the rule-based advice sub-module 1 17 selects and applies the appropriate rule set 1 19 to the hidden patterns (or situations) received from the user 101. Additionally, the advice sub-module 117 determines the rule(s) in the selected rule set 119 that is appropriate for the received hidden patterns and provides advice based on the selected rule(s). The manner in which the advice sub-module 117 selects the rules is described herein conjunction with FIG. 2. The advice sub-module 117 returns or outputs to the query application 112, the advice generated in response to the input, i.e., answer and/or relevant hidden patterns, from the query application 112 via the characterizing sub-module 115. The query application 112 transmits the generated advice to the user 101 over the computer network 106.

However, if the advice module 117 determines that are no rule in the rule sets 119 that is applicable to the situation received from the characterizing sub-module 115, the advice sub-module 117 informs the user 101 that no expert advice is available for these hidden patterns. Preferably, the advice sub-module 1 17 informs the user to seek a human advice, such as a trained professional golf instructor.

Turning now to the process by which the instruction module 320, particularly the advice sub-module 117, determines and generates the appropriate advice to the user is described herein. Generally, a human instructor does not provide multiple, simultaneous instructions to a user (student), but a single instruction at a time to avoid the possibility of confusing or “overloading” the student. In other words, the student's performance may degrade because he is unable to follow all of the instructions or because he is unable to determine which instruction to follow first. It is appreciated that the instruction module 320, i.e., the query/mining application 112, can generate multiple advice from the received hidden patterns. In accordance with an embodiment of the present invention, the query/mining application 112 preferably prioritizes the hidden patterns so that the advice sub-module 117 generates a single advice at a time to the user 101. Alternatively, the advice sub-module 117 can prioritize the advice generated from the hidden patterns and provide a single advice at a time to the user 101. For example, the advice sub-module 1 17 can store and access advice given to various users over time in an advice history file or database 118. The advice sub-module 117 can use this advice history to (a) determine a situation wherein a particular user is being presented with the same advice repeatedly, and hence, suggest that he/she seek the advice of a human expert to break out of the “loop”, or (b) determine situations where a particular piece of advice has been found to be unhelpful for most users, and generate that advice with a lower priority or do not consider or generate that advice.

Although only one rule set 119 is shown in FIG. 1 for simplicity, it is appreciated that the present invention contemplates using a plurality of rule sets 119. The rule sets 119 are generated using inputs from experts in various domains, i.e., a professional golf instructor, a professional stock trader, etc. These experts describe errors, i.e., common and uncommon errors, errors made by beginners, etc., made in their particular domain, as well as standard techniques to avoid these errors.

In accordance with an embodiment of the present invention, when the advice sub-module 117 detects situations when human advice is necessary, it provides the user with reports of his/her performance, as well as advice offered by the rule-based advice sub-module, so that the user can take these reports and advice to a human expert for consultation. This is analogous to a patient taking his/her x-rays, CAT scan, MRI, etc. to a specialist for a consultation. Alternatively, the expert can access these reports and advice on-line and provide personalized instructions to the user 101, which are preferably used to update the advice history and the rule set 119 accordingly.

Preferably, the rule sets 119 are updated over time with new rules (i.e., advice) that address old and new situations problems or errors, i.e., new advice to an existing problem. Also, any advice provided by the human expert to a user for situations not addressed by the present system can be added to the rule set 119. That is, the ATS can learn new rules while the users learning new skills to improve their performance.

In accordance with an embodiment of the present invention, the instruction module views the advice provided by the human expert as part of a learning continuum. The expert's advice can be inputted into the system as part of advise history as described herein and/or added to the rule set as new rules. Preferably, the system tags or identifies such advice or input as being provided by a human expert. In this manner, the system can track the effectiveness of the advice provided by the human expert and incorporate such advice if determined to be effective for a particular situation, i.e., add the expert's advise to the rule set.

In accordance with an embodiment of the present invention, each rule in a rule set consists of two components: the first (referred to as the situation) is an attribute-valued string that contains values for various attributes. For example, in the golf application, “putt length of 5-10 feet, on a par-5 hole”, can be described in terms of two attributes. The first attribute being the “Putt Length” has a value of “5-10 feet,” and the second attribute being the “Par” has a value of “5”. Similarly, in a gardening domain, the situation “loamy soil” can be described in terms of an attribute “type of soil”, having the value “loamy”.

The second component of a rule (referred to as the advice) is a data structure that contains advice on how to handle the situation described in the situation component. Various implementations of the advice are possible and contemplated in the present invention. In accordance with an embodiment of the present invention, the advice is represented as a set of strings containing some text, such as “1) grip the golf club firmly; 2) keep your head straight”. Alternatively, the advice is represented in terms of a set of attribute-valued strings, similar to the situation. For example, the set of advice, “grip the golf club firmly” and “keep your head straight,” can be described as a set of two attributes, “grip” having the value “firm” and “head” having the value “straight”. The entire domain can thus be broken down into a set of advice attributes, and the advice can be one or more attribute-valued strings with attributes from the advice set.

Similarly, in a call center domain, the situation “calls at night” can be described in terms of an attribute “time of call”, having the value “night”. Examples of advice in the call center domain can be “train agents for etiquette”, which can be represented as an attribute-valued string, with the attribute “type of training” as having the value “etiquette”.

Turning now to FIG. 2, there is illustrated a flowchart for describing the manner in which the advice sub-module 117 (FIG. 1) determines and generates an advice in response to a particular situation in accordance with an embodiment of the present invention. The query application 112 issues an advice request to the advice sub-module 117 at step 201. The advice request data structure consists of a pattern P, on which advice is required, as well as the name of a domain for which the advice is being requested. It is appreciated that the pattern may itself be an attribute-valued string. The advice sub-module 117 retrieves the appropriate rule set for the specific domain from the pre-determined and pre-stored rule sets 119 for various domains at step 202, and then determines which rule(s) in the selected rule set is applicable to the pattern associated with the advice request.

The advice sub-module 117 first sets a counter I to 1 at step 203 and then examines the Ith rule in the selected rule set at step 204. At step 205, the advice sub-module 117 makes an inquiry to determine if the values of the attributes in the situation component of the Ith rule overlap the situation characterized in the pattern P. If the inquiry at step 205 is answered in the negative, the advice sub-module 117 proceeds to step 207 and increments the counter I by 1.

However, if the inquiry at step 205 is answered in the affirmative, the advice sub-module 117 marks the Ith rule as a possible candidate for advice to be provided to the user 101 at step 206. The advice sub-module 117 then increments the counter I by 1 at step 207.

At step 208, an inquiry is made to determine if the value of the counter I is greater than the number of rules in the selected rule set. If the inquiry at step 208 is answered in the negative, the advice sub-module 117 continues the search for other possible candidates for advice by repeating steps 204-207. However, if the inquiry at step 208 is answered in the affirmative, the advice sub-module 117 proceeds to step 209 to determine if any rules have been selected as possible candidate for advice 120.

If the inquiry at step 209 is answered in the negative, the instruction module 117 returns a notification indicating that no advice has been found to the user at step 210.

However, if the inquiry at step 209 is answered in the affirmative, the advice sub-module 117 optimizes the advice component of the candidate rules to the user at step 211, according to the optimizations described below, and returns the resulting advice components to the user at step 212.

It is appreciated that the advice sub-module 117 can optimize the set of candidate rules in various possible ways. In accordance with an embodiment of the present invention, the advice sub-module 117 returns all possible candidates, preferably ranked in decreasing order of appropriateness. In accordance with an aspect of the present invention, the advice sub-module 117 can expand the set of possible candidates by finding or looking for overlap between the input pattern and the first component of the rules. That is, the advice sub-module 117 expands the set of possible candidates by relaxing the stringent sub-string condition of the process described herein. In accordance with another embodiment of the present invention, the advice sub-module 117 returns only the most appropriate advice or provides the advice to the user 101 in an interactive manner. In other words, the advice sub-module 117 presents the user 101 with a set of choices, i.e., a decision tree. Those skilled in the art understands that such interaction can be implemented using other techniques, such as decision tree, question and answer system, etc. Depending on the user selection, the advice sub-module 117 provides different pieces of advice to the user 101. Those skilled in the art will realize that several such implementations are possible, without departing from the spirit and scope of the present invention.

In accordance with still another embodiment of the present invention, the advice sub-module 117 keeps track of the advice presented to users over time as well as the extent of improvement of users after following that advice. The advice sub-module 117 can advise the user when it thinks that human intervention is necessary for the user to improve his/her performance. In accordance with an aspect of the present invention, the advice sub-module 117 can determine if a human intervention is necessary by checking if the same advice is repeatedly being presented to a specific user. If, for example, the same advice has been presented ten times to the user 101 with no noticeable improvement, the advice sub-module 117 can suggest that it is time for the user 101 to seek human advice because the advice offered is either ineffective or being improperly followed. Alternatively, the advice sub-module 117 can determine if the user 101 is being presented with the same set of advice in a repetitive manner, in which case the advice sub-module 117 can suggest human intervention. In accordance with another aspect of the present invention, the advice sub-module 117 has a range of possibilities while providing a particular piece of advice to the user 101. When all these possibilities are exhausted, the advice sub-module 117 can then suggest human intervention. For instance, to get more loft, one could be advised to use a club with a higher number. However, there being only a finite number of clubs, if the user does not achieve sufficient loft even when using the club of the highest number, the advice sub-module 1 17 may refer the user to a golf professional.

It is entirely possible for the advice sub-module 117 not to find any relevant advice at step 209 in response to the situation presented. Again, different embodiments of the advice sub-module 117 can handle this situation in variety of ways. The advice sub-module 117 can inform the user 101 that no relevant advice is currently available. Alternatively, the advice sub-module 117 can inform the user 101 to check later for any additional information or advice. That is, the advice sub-module 117 can be updated later to handle such situation, i.e., “fresh” advice. Preferably, the advice sub-module 117 generates a notification to the system administrator of the ATS or system 300, with details of the situation in which no relevant advice was found. The system administrator then contacts the expert in that specific domain, and augments or updates the rule set 119 for that specific domain, if possible, based on the advice of the expert. When the user asks for advice on the same pattern again, since the rule set 119 has been augmented or updated, the user 101 is now presented with some relevant advice.

In accordance with an embodiment of the present invention, the ATS comprising data collection, data analysis and instruction, in part or in its entirety, is particularly suitable for an Internet-based implementation. Users can use their Internet browsers (on hand-held devices or on their computer) to access all parts of the system (including collection, querying and analysis, and instruction). This makes the system amenable for use by large numbers of users. The data collection and data input modules provide templates to guide users. Different users can make use of different templates and customize those templates. The query application 112 allows the users to not only get answers to their queries but also alert them to the hidden patterns in their data. The potential for self-improvement based on discovery of such hidden patterns cannot be emphasized enough. Finally, the advice sub-module 117, in conjunction with the characterizing sub-module 115, provides the users with advice automatically, i.e., without human intervention. Since each step is automated, it is clear that it is possible to support very large numbers of users as well as provide training and instruction for a large number of domains simultaneously over a communication network, such as the Internet.

While the present invention has been particular shown and described with reference to various embodiments, it will be readily appreciated that various changes may be made without departing from the spirit and scope of the invention. For example, instead of storing the information in various databases, all of the information may be stored in a single database or a single storage device. Also, all of the modules, sub-modules, and databases may be comprised in a single computer or computer network. Further, it is appreciated that each module, sub-module, and database may be mirrored for redundancy to provide a more reliable and robust system. The information stored in various databases may be additionally backed-up in a central database every pre-determined interval or during off-peak hours to provide recoverability, efficiency, and security. Alternatively, each database may back up another database so that there is always primary and secondary databases for any given information.

While the present invention has been particularly described with respect to the illustrated embodiment, it will be appreciated that various alterations, modifications and adaptations may be made on the present disclosure, and are intended to be within the scope of the present invention. It is intended that the appended claims be interpreted as including the embodiment discussed above, those various alternatives, which have been described, and all equivalents thereto.

What is claimed:

1. A self-training method, comprising the steps of:
receiving data regarding a user's performance in a domain;
analyzing said data to determine user's domain-specific performance metrics;
generating advice based on said performance metrics.

2. The method of claim 1, further comprising the step of updating said data with user's performance after following said advice.

3. The method of claim 1, further comprising the step of collecting data by said user based on domain-specific attributes, said attributes describing at least one of the following: said user, and a particular event or transaction relating to said user's performance in said domain.

4. The method of claim 3, wherein the step of analyzing includes the step of mining said data to find hidden patterns in said performance metrics; and wherein the step of generating generates advice based on said hidden patterns and said performance metrics.

5. The method of claim 4, wherein the step of analyzing additionally includes the step of characterizing said hidden pattern based on at least one of the following: predetermined domain-specific performance metrics, average performance of said user, and average performance for all users in said domain.

6. The method of claim 1, wherein the step of generating prioritizes said advice generated for said user and provides a single advice to said user.

7. The method of claim 6, further comprising the step of storing advice provided to said user in a database to provide an advice history; and wherein the step of generating generates said single advice based on said advice history and said performance metrics.

8. The method of claim 7, wherein the step of generating includes the step of generating a message for said user to seek a human intervention if it is determined that said user is ignoring or incorrectly following said advice, or if no additional advice is available to said user.

9. The method of claim 5, wherein the step of generating includes the steps of prioritizing said advice generated for said user;
providing a single advice to said user; and
storing advice provided to said user in a database to provide an advice history; and
wherein the step of generating generates said single advice based on at least one of the following: said advice history, said hidden patterns and said performance metrics.

10. The method of claim 1, wherein the step of generating generates said advice using a rule-based system.

11. The method of claim 10, further comprising the step of updating said rule-base system with new rules or advice over time.

12. The method of claim 1, wherein said data relates to performance of a team or a group of users as a single entity.

13. A system for providing personalized instruction to a plurality of users, comprising:
a storage device for storing data received from at least one user to provide a user data, said user data relating to said user's performance in a domain; and
an analyzing module for analyzing said user data to determine domain-specific performance metrics for said user; and
an instruction module for generating advice based on said performance metrics of said user.

14. The system of claim 13, wherein said storage device is operable to update said user data with said user's performance after following said advice.

15. The system of claim 13, wherein said user data includes domain-specific attributes, said attributes describing at least one of the following: said user, and a particular event or transaction relating to said user's performance in said domain.

16. The system of claim 15, wherein said analyzing module is operable to perform data mining on said user data to find hidden patterns in said performance metrics; and wherein said instruction module is operable to generate advice based on said hidden patterns and said performance metrics.

17. The system of claim 16, wherein said instruction module is operable to characterize said hidden pattern based on at least one of the following: pre-determined domain-specific performance metrics, average performance of said user, and average performance for all users in said domain.

18. The system of claim 13, wherein said instruction module is operable to prioritize said advice generated for said user and to provide a single advice to said user.

19. The system of claim 18, wherein said storage device is operable to store advice generated for said user to provide an advice history; and wherein said instruction module is operable to generate said single advice based on said advice history and said performance metrics.

20. The system of claim 19, wherein said instruction module is operable to generate a message for said user to seek a human intervention if it is determined that said user is ignoring or incorrectly following said advice, or if no additional advice is available to said user.

21. The system of claim 17, wherein said instruction module is operable to prioritize said advice generated for said user and to provide a single advice to said user; wherein said storage device is operable to store advice provided to said user as an advice history; and wherein said processing device is operable to generate said single advice based on at least one of the following: said advice history, said hidden patterns and said performance metrics.

22. The system of claim 13, wherein said instruction module generates said advice using a rule-based system.

23. The system of claim 22, wherein said instruction module updates said rule-based system with new rules or advice over time.

24. The system of claim 13, further comprising a communications network and a receiving module for receiving data from said user over said network.

25. The system of claim 24, further comprising a portable device for receiving said advice from said instruction module over said network.

26. The system of claim 25, wherein said communications network is an Internet.

27. The system of claim 13, wherein said user data relates to performance of a team or a group of users as a single entity.
